(19) United States
(12) Patent Application Publication
(10) Pub. No.: US 2003/0120631 A1
(43) Pub. Date: Jun. 26, 2003

(54) Method and system for hierarchical data entry

(75) Inventor: Richard N. Blazey, Penfield, NY (US)

Correspondence Address: Milton S. Sales, Eastman Kodak Company, Patent Legal Staff, 343 State Street, Rochester, NY, 14650-2201, US

(73) Assignee: Eastman Kodak Company

(21) Appl. No.: 10/027,380

(22) Filed: Dec. 21, 2001

(51) Int. Cl. G06F 7/00

(52) U.S. Cl. 707/1

(57) ABSTRACT

A system and method for entering data associated with a digital image by providing a display screen having a plurality of second selection items; choosing one of the second selection items for entering into a database or going to a next display screen for presenting a next set of selection items; and repeating the above steps until a selection has been made for entering a selection item into a predetermined field of the database.

### FIELD OF THE INVENTION

The present invention is directed to the field of data entry into a database and, more particularly, to a method and system of data entry by selecting pre-defined categories arranged in a hierarchical manner on a computer.

### BACKGROUND OF THE INVENTION

Data entry into the fields of a computer database can be a time-consuming and tedious process. Each item in the database may require a clerk using a keyboard to make entries relating to large number of categories. An example of such a database may be found in the real estate industry where there is a need to categorize the thousands of houses in its respective databases with respect to multiple characteristics (size, color, type of exterior, age, appliances, number and type of rooms, to pick but a few examples) so that they may easily be found by potential buyers. Currently for this industry, this categorization is limited to a practical number of database fields to keep the time needed to enter the data within practical limits. Certain characteristics of the house are also described in written summaries prepared by each agent. These summaries are as unique as the agent that prepared them and may describe the same characteristics in different words or may not describe at all some minor characteristics of interest to some buyers (e.g., corner lot, tree in front yard). When these summaries are later used to catalog houses in a database, this lack of uniformity in terminology may mean that searching does not always return all the houses that may interest a buyer, or may return incorrect or inappropriate results.

Commonly assigned and co-pending US patent application entitled A METHOD AND SYSTEM FOR CATALOGING IMAGES Ser. No. 09/640,938 filed on Aug. 17, 2000 to Squilla, et al., addresses some aspects of these problems by providing iconic representations of key categories such as, as applied to the real estate example at hand, number of bedrooms, number of bathrooms, appliances included etc. The approach of Squilla, et al. simplifies both data entry and retrieval by eliminating the need to type entries and also improves the uniformity in that there is only one choice to describe a particular characteristic. However, where a very large number of categories is required for a complete and accurate description, the icons quickly become difficult to recognize as their number increases past a few dozen.

When it is necessary to retrieve items from a computer database where many choices are possible, it is known to use a hierarchical series of menus of selection items where levels of menus appear sequentially as needed. For such a system, see U.S. Pat. No. 5,784,069 to Morimoto, et al. which discloses a hierarchical series of linked menu levels used to select items related to location in an on-board vehicle navigation system. However, this approach does not address the need where a large number of characteristics must be entered into a database in order to fully describe an item in the database

Thus there remains a need for a method for faster and easier and more consistent data entry to describe complex items so that they may be accurately searched in databases with a great many more fields than is practical if each field must be entered using a keyboard.

### SUMMARY OF THE INVENTION

In accordance with one aspect of the present invention, there is provided a computer software product comprising a computer readable storage medium having a computer program which when loaded into a computer having a searchable database running thereon causes the computer to perform the following steps of providing a first display screen having a plurality of first selection items; enabling a user to select one of the first selection items, which results in a second display screen having a plurality of second selection items; enabling the user to choose one of the second selection items for entering into a database or going to a next display screen for presenting a next set of selection items; and enabling the user to repeat the above steps until a selection has been made for entering at least one of the selection items into a predetermined field of the database.

In accordance with another aspect of the present invention, there is also provided a method of entering data into a searchable database, comprising the steps of providing a first display screen having a plurality of first selection items; selecting one of the first selection items, which results in a second display screen having a plurality of second selection items; choosing one of the second selection items for entering into a database or going to a next display screen for presenting a next set of selection items; and repeating the above steps until a selection has been made for entering a selection item into a predetermined field of the database.

In accordance with yet another aspect of the present invention, there is also provided a system for entering data into a searchable database, the database having at least one hierarchical data entry path, the path comprising at least two data entry levels, wherein each level has a plurality of selection items, one of the selection items being used for selecting the second level.

In accordance with still another aspect of the present invention there is provided a data entry device for entering data into a searchable database running on a computer, comprising a data entry module having a user interface displaying at least one hierarchical data entry path, the path comprising at least two data entry levels, wherein each the level has a plurality of selection items, one of the selection items being used for selecting the second level; a digital image capture and storage module able to capture and store a plurality of images; and a processor able to tag at least one of the stored images as being associated with at least one of the selection items.

In accordance with yet another aspect of the present invention there is provided a method of entering data using a digital camera that is to be downloaded into a searchable database running on a computer, comprising the steps of capturing an image using said digital camera; entering a selection item into a predetermined field of said database from a first set of selection items for said digital image; and down loading said digital images and associated data into said database.

The above, and other objects, advantages and novel features of the present invention will become more apparent from the accompanying detailed description thereof when considered in conjunction with the following drawings.

### BRIEF DESCRIPTION OF THE DRAWINGS

In the detailed description of the preferred embodiments of the invention presented below, reference is made to the accompanying drawings in which:

FIG. 1 is a schematic diagram of a system for use in practicing the present invention;

FIG. 2a-2d are computer display screens illustrating the operation of a software implementation of the present invention;

FIG. 3 is a schematic diagram illustrating the hierarchical structure the present invention; and

FIG. 4 is a depiction of a data entry device made in accord with the present invention.

### DETAILED DESCRIPTION OF THE INVENTION

It is the purpose of this invention to make it faster and easier to catalog complex items so that they may be searched in databases with a great many more fields than is practical if each field must be individually entered using a keyboard. It is another purpose to make the catalog tool easier to use for storage and retrieval of items from a database. Still another purpose of this invention is to increase the uniformity with which characteristics are entered into a database.

The present invention provides that data entry is accomplished by providing selection items, such as icons, on a computer data entry screen arranged in a tree hierarchy using multiple data entry levels with one data entry level per screen. In this way a great multiplicity of selection item choices can be accessed using just a few clicks of a mouse. The total number of fields that can be characterized by the method illustrated may be understood by referring to the formula below:

$${N}_{icons} = {\sum }_{i = 0}^{Nlevels} {N}_{0} {R}^{i - 1}$$

In the formula, N_{icons} is the total number of icons in the tree hierarchy, Nₒ is the number of selection items (icons) on each data entry level screen, Nₗₑᵥₑₗₛ is the number of levels in the hierarchy and R is the number of branches on level N for each selection item on the previous level (N−1) . As an example, with Nₒ set at 3 and R set to 5 and Nₗₑᵥₑₗₛ=3 the formula calculates that the hierarchy contains 93 icons any of which can be accessed with just 3 mouse clicks. A more general form of the formula is shown below where the number of selection items N on each level may be different.

$${N}_{icons} = {\sum }_{i = 0}^{Nlevels} {N}_{i - 1} {R}_{i - 1}$$

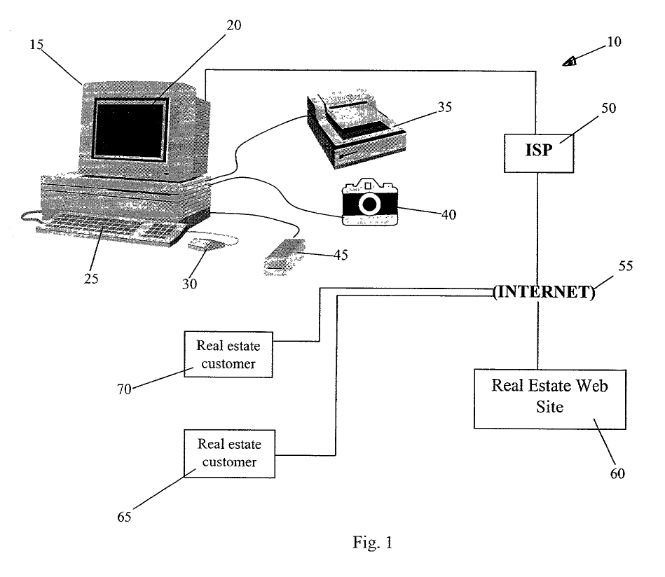

Referring now to FIG. 1, there is illustrated a system 10 for use in entering data in a real estate database which incorporates the data entry method of the present invention. The system includes a computer 15 for processing data and information. The computer 15 also includes an appropriate processor and memory storage for the running of software programs and storing digital data as is customarily carried out by computers. In the embodiment illustrated, computer 15 is a personal computer having a display device 20 which in the embodiment shown is a CRT. The computer 15 also includes input devices 25 and 30 for entering of data into the computer 15 by the user. In particular, input device 25 is a keyboard and input device 30 is a mouse. However, it is to be understood that any input device or means may be employed, for example, but not by way of limitation, a touch screen or a voice input system. A wireless input device, such as a wireless hand-held PDA could easily be interfaced to such a system as well. A scanner 35 is provided for scanning of hard copy images of houses, real estate properties or other items to be entered into the database. The scanned images captured by scanner 35 are digitized and forwarded to the computer 15 as is well known in the art. In addition a digital camera 40 or image memory card reader 45 may also be connected to the computer 15 for the direct input of digital images of real property. Computer 15 is also provided with appropriate communications hardware and software, as is well known in the art, for allowing communication with third parties. In the embodiment illustrated, the communications hardware and software allows communication to an internet service provider ISP 50 which in turn allows communication with the internet 55. Data recorded in the database regarding real properties for sale are uploaded from computer 15 to the real estate web site 60 where this information may be accessed by real estate customers 65 and 70 who run searches on the database also using computers from a remote location.

The system of FIG. 1 serves only to illustrate one use of the data entry method of the present invention. It will be understood that the practice of the invention is not limited to this example, and the data entry method of the invention may be applied to any computer database where the number of data fields required to be entered is large and lend themselves to the hierarchical method herein disclosed. Such a computer database could be running not only on a networked system as shown in FIG. 1, but also on a variety of stand-alone devices such as a personal computer, PDA, hand-held or palm-top computer. Even the display and the keys on a cell phone could be adapted to such a method of data entry.

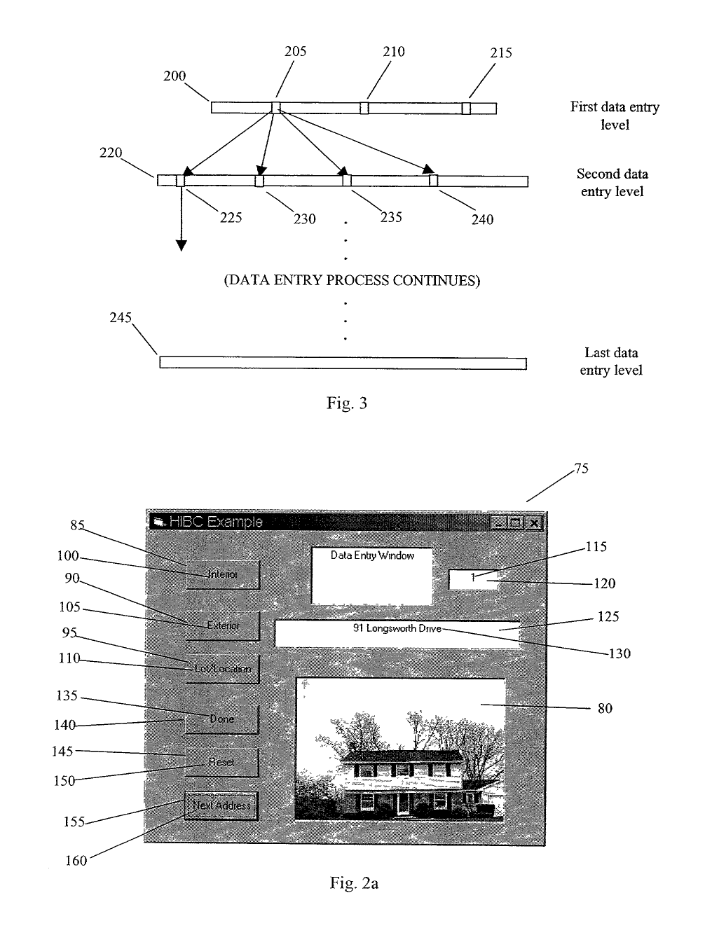

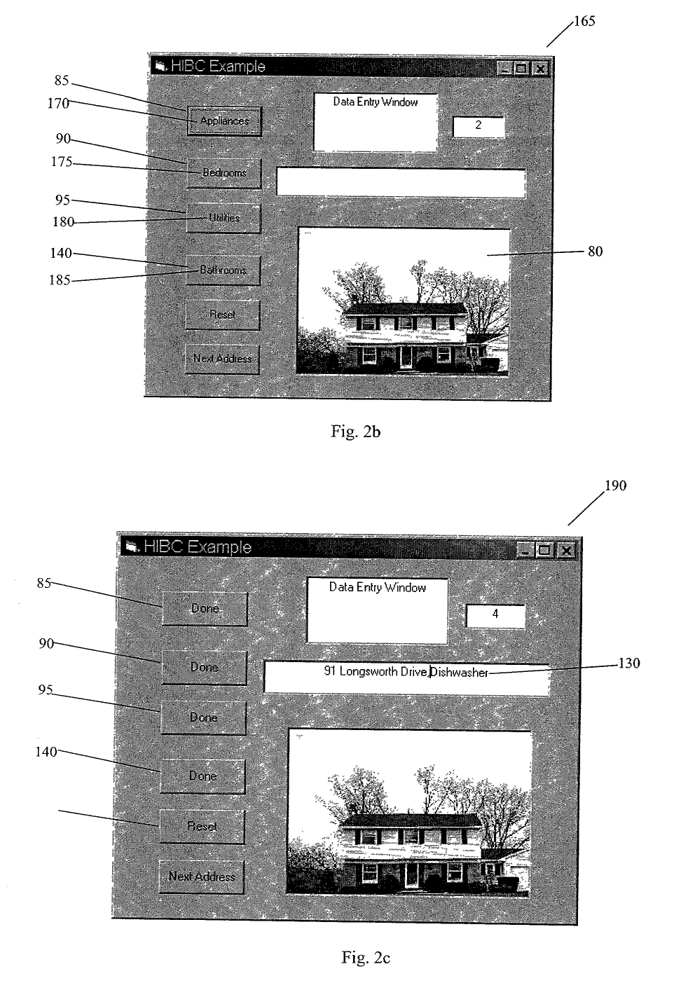

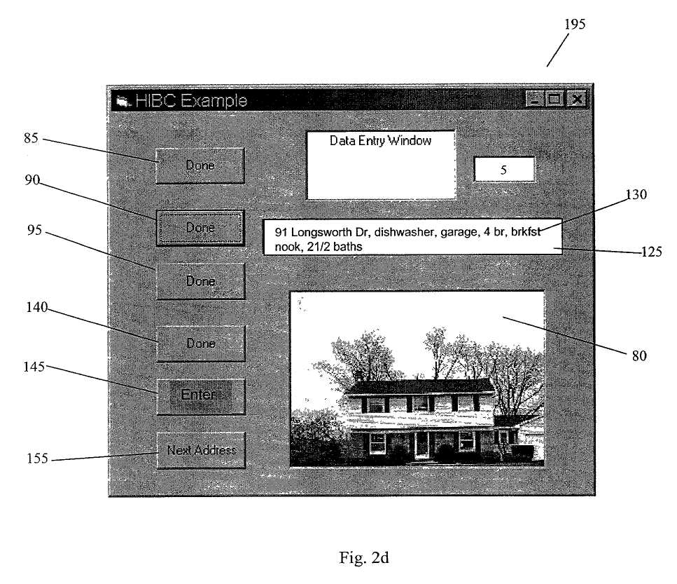

FIGS. 2a-2d show selected computer display screens of a preferred embodiment of the data entry method of the present invention implemented in a simple software program for use in a real estate sales operation. For convenience, in the illustration of FIGS. 2a-2d, selection items are represented by selection buttons labeled with text. It will be appreciated, however, that selection items may also be represented by selection buttons which have an image or other graphic (such as graphical representation of an appliance) on them to indicate their purpose. A mixture of selection buttons, some labeled with text and some with a graphic image could also be used. Selection buttons may also have any shape which is convenient, including an overall shape indicative of their use (such as, for example, the shape of an appliance). Other types of well-known selection items for hierarchical data entry into a computer where selection of an item causes branching to another screen may also be adapted to this method. Examples include, but are not limited to, linked blocks of text or symbols, or various kinds of active regions on a screen which, when selected, cause an action such as branching to another page or level.

FIG. 2a shows an initial data entry screen 75 including an image of a house 80 for which data is to be entered. Data entry selection items are represented by selection buttons s 85, 90 and 95 having labels “Interior” 100, “Exterior” 105 and “Lot/Location” 110 respectively, relating to particular features of the house 80. The data entry level of the screen is shown by the numeral 115 in indicator window 120. As data entry selections are made, window 125 shows the accumulating data entry string 130 so that the user can keep track of items already selected for entry. The label “Done” 135 appearing on selection button 140 is used to indicate there is no additional choice to be made using this selection button at the particular data entry level. Selection button 145 with label “Reset” 150 is used to return to the top of the tree for a new entry relating to the house. Selection button 155 with label “Next Address” 160 resets the system for data entry of different house in the database.

Proceeding now with the operation of the embodiment illustrated, for example, when the “Interior” selection button 85 is selected, the system branches to a second level of data entry shown in FIG. 2b by computer data entry screen 165. In FIG. 2b the labels on the selection buttons have changed to four selection items relating to the interior features of the house 80. In FIG. 2b, these four interior features are represented by selection buttons 85, 90, 95 and 140 with labels “Appliances” 170, “Bedrooms” 175, “Utilities” 180 and “Bathrooms” 185 respectively. Selecting, for example, the selection button 85 labeled “Appliances” causes the system to branch to a third level (not shown) where the selection button labels have changed again and relate to types of appliances. The data entry process for house 80 continues in a like manner until selection of an item no longer brings up additional choices corresponding to the last data entry level of a particular branch of the data entry tree hierarchy. FIG. 2c shows the last data entry screen 190 for the entry branch relating to appliances. In FIG. 2c it is shown that the selection item “dishwasher” has been added to the data entry string 130 for this house. Selection buttons 85, 90, 95 and 140 in FIG. 2c are all labeled “Done” indicating that the data entry system is at the end of the hierarchical tree for the “Appliances” category and no additional selections are to be made for this category. Selection of the selection button 145 labeled “Reset” in FIG. 2c will now return the user back to a higher level in the tree so that additional information about the house may be entered. For example, once data about appliances has been completed, the “Reset” selection button will return the system to screen 165 FIG. 2b) where data may be entered for another attribute such as “Utilities”. FIG. 2d shows an example of the final data entry screen 195 where data entry for an entire house has been completed and the completed data entry string 130 is shown in window 125. On screen 215, selection buttons 85, 90, 95 and 140 now are all labeled “Done” indicating there is no additional data to be added for the house 80. Selection button 145 is now labeled “Enter”. When selection button 145 is selected, all the data for house 80 is transferred by means of methods well known by those skilled in the art into a conventional database such as Microsoft Access©, or any suitable computer database, running on essentially any computing platform which will support the software. In the real estate example provided, such a database has various fields corresponding to the data entry categories of “Interior”, “Exterior” and “Lot/Location” and their subcategories. The step of data entry into the database will in some instances cause the entering of more than one selection item into the same field of the database. For example, more than one entry for types of appliance may be entered into the “Appliance” field for a house where more than one appliance is being offered.

When data entry for a particular house has thus been accomplished and the data transferred into a database, selection of the selection button 155 on screen 195 labeled “Next Address” starts the data entry system over again at the beginning for the next house to be entered.

It will be understood that the hierarchical data entry method of the present invention may also be adapted to many other types of database structures. For example, a real estate database might alternatively be organized according to which features in the house are associated with a particular floor in the house. The hierarchical data entry would then simply branch from floor to floor, allowing entry of such items as rooms on that floor, types of appliances on that floor, etc.

Once data has been entered into the database, then data may also of course be retrieved from the database using any of the well known methods of data retrieval from a database including the construction of a retrieval search query using a hierarchical system analogous to that disclosed here for data entry. Thus a user wishing to search the database would, by means of a series of hierarchical screens, enter the characteristics (number of rooms, type of siding, lot size, etc) of the type of house being sought and the database would return and display the choices fitting the description.

In order to make more clear the relationship between the various data entry level screens of the embodiment illustrated in FIGS. 2a-2d, there is shown in FIG. 3 a schematic representation of the relationships between the data entry levels of the embodiment illustrated. In FIG. 3 the first data entry level 200 corresponds to the first data entry screen 75 of FIG. 2a, and the three data entry points 205, 210 and 215 correspond to the three selection items 85, 90 and 95 of the first screen of FIG. 2a. When selection item 205 is chosen, the entry system branches to the second data entry level 220, corresponding to the second data entry screen 165 of FIG. 2b where four new data entry points 225, 230, 235 and 240 corresponding to selection buttons 85, 90, 95 and 140 respectively are presented. When data entry point 225 is selected the system continues to branch as described earlier and the entry process continues until the last data entry level 245 for a particular branch has been reached. No data entry points are shown for level 245, which corresponds to the entry screen 195 of FIG. 2c. As described earlier, level 245 is the last data entry level for the particular branch of the entry tree and no additional choices need to be made at this level.

A particular screen layout, style and “look and feel” of the computer display screens has been illustrated for the embodiment shown in FIGS. 2a-2d, but it will be understood that essentially any style, screen layout, or “look and feel” that allows practice of the method of the invention may be employed. For example, in the embodiment illustrated in FIGS. 2a-2d the number of selection button selection items at each level of entry remains the same (four) and the labels on the selection buttons change when the system branches to another entry level. Other embodiments are also possible, however, for example where the numbers of selection items on the entry screens change from entry level to entry level, reflecting the number of entry items possible at that level. For example, if the “Appliances” selection button is selected on a screen which has three other selection choices (for a total of selection buttons), the system could next branch to an entry screen where six selection button choices, corresponding to a selection of six different appliances, could be provided. Also, instead of indicating that the last entry point on a branch of the entry tree has been reached by having the selection button label change to “Done”, the system could simply have the selection button(s) disappear when there is no longer another choice to be made. Other variations and embodiments are also possible within in the scope of the invention.

The embodiment illustrated in FIGS. 2a-2d is directed to data entry for an application in the real estate industry but it will be appreciated that the method of data entry of the present invention could be used for any number of other applications. Any computer database where items must be characterized by a large number of features would benefit from this method of data entry. The method would, for example, be useful for a database which contained other items other than real estate being offered for sale, such as, for example, automobiles or sporting equipment. Other examples where the method would be useful include databases in the insurance industry where the features of an item insured must be described, or the details of a particular insurance claim relating to an accident or other liability must be entered. The entry of particular kinds of medical data relating to a patient's medical record could also be well served by the method disclosed. The entry of data relating to the inventory of a large number of items, for example in a grocery store, is yet another example.

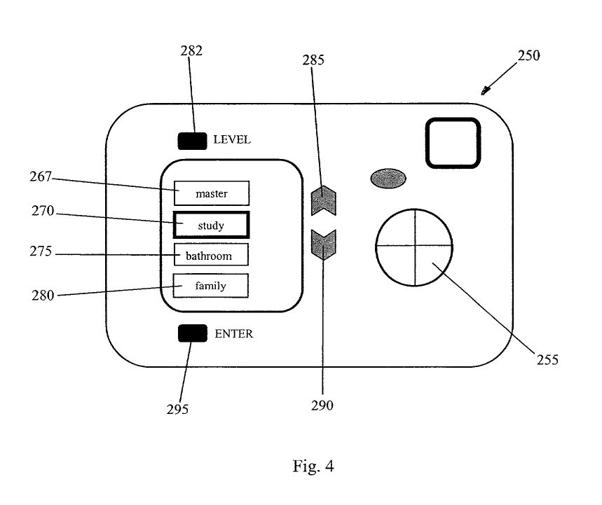

As described previously, a variety of data input devices may be used to practice the present invention. A particularly useful device for data entry comprises a digital camera where the digital camera is also used to capture images to be stored in the database. In FIG. 4 is a rear view of digital camera 250 useful for the real estate database application already discussed. Digital camera 250 has stored in memory (not shown) the hierarchical data entry tree described earlier and shown previously in FIGS. 2a-2d. On camera 250, control button 255 is used to toggle between two modes of use for display 260 to (1) either display captured images for review, or (2) to display the data entry tree. As shown in FIG. 4, the display 260 is set for the mode of displaying the data entry tree. Button 282 labeled “Level” is used to navigate between levels in the data entry hierarchy. In the example shown in FIG. 4, the “Interior” level of the hierarchy with selection items 267, 270, 275 and 280, corresponding to various types of rooms found in the interior of a house is displayed on display 260. Buttons 285 and 290 are used to navigate between selection items displayed and determine which of the selection items is highlighted. In FIG. 4, the selection item 270 for the room type “Study” is shown highlighted. When using the camera, the real estate agent first captures a picture of the study, reviews the image using the image review mode of the display 260 and, if the image is acceptable, switches the camera to the data entry mode and selects the “Study” selection item 260 using navigation buttons 285 and 290. When the button 295 labeled “Enter” is activated, the image of the study is tagged in camera memory with its appropriate position in the data entry hierarchy. In like manner, pictures of other items in the data entry hierarchy may also be captured including, for example, other rooms, appliances, or a close-up of the exterior of the house. If it is not desired to take a picture of a particular item, but merely to indicate the presence of a particular feature in the house, a data entry alone can be made indicating that the feature is present in the house. Once all the data and pictures desired for a particular house have been recorded, the data from the camera is transferred to the computer (see part 15, FIG. 1) where the database is resident, and the images and data are entered into the database using known prior art methods. When data for a house is later retrieved by a user of the database, the pictures associated with the features of the house will be made available for viewing (not shown). Once a particular house has been retrieved from the database, a series of selection buttons are presented, allowing the user to access the pictures of the various features of the house. For example, the user is not only able to learn that a particular house has three bedrooms, or that it has a washer and drier, but will also be able to see pictures of the bedrooms, or pictures of the appliances.

It is to be understood that various other changes and modifications may be made without departing from the scope of the present invention. The present invention being defined by the claims set forth below.

### PARTS LIST

10 system

15 computer

20 display device

25 input device

30 input device

35 scanner

40 digital camera

45 memory card reader

50 internet service provider

55 internet

60 web site

65 customer

70 customer

75 data entry screen

80 image

85 selection button

90 selection button

95 selection button

100 label

105 label

110 label

115 numeral

120 indicator window

125 window

130 data entry string

135 label

140 selection button

145 selection button

150 label

155 selection button

160 label

165 data entry screen

170 label

175 label

180 label

185 label

190 data entry screen

195 data entry screen

200 data entry level

205 data entry point

210 data entry point

215 data entry point

220 data entry level

225 data entry point

230 data entry point

235 data entry point

240 data entry point

245 data entry level

250 digital camera

255 control button

260 display

265 button

267 selection item

270 selection item

275 selection item

280 selection item

282 button

285 navigation button

290 navigation button

295 button

What is claimed is:

1. A computer software product comprising a computer readable storage medium having a computer program which when loaded into a computer having a searchable database running thereon causes the computer to perform the following steps:
a) providing a first display screen having a plurality of first selection items;
b) enabling a user to select one of said first selection items, which results in a second display screen having a plurality of second selection items;
c) enabling said user to choose one of the said second selection items for entering into a database or going to a next display screen for presenting a next set of selection items; and
d) enabling said user to repeat step (c) until a selection has been made for entering at least one of said selection items into a predetermined field of said database.

2. A computer software product according to claim 1, wherein said selection items are selection buttons.

3. A computer software product according to claim 1, wherein said selection items are linked text blocks.

4. A computer software product according to claim 1, wherein said selection items are linked regions on a screen.

5. A computer software product according to claim 1, wherein at least one said selection items is labeled with a text label.

6. A computer software product according to claim 1, wherein at least one of said selection items is labeled with a graphic image.

7. A method of entering data into a searchable database running on a computer, comprising the steps of:
a) providing a first display screen having a plurality of first selection items;
b) selecting one of said first selection items, which results in a second display screen having a plurality of second selection items;
c) choosing one of the said second selection items for entering into a database or going to a next display screen for presenting a next set of selection items; and
d) repeating step (c) until a selection has been made for entering a selection item into a predetermined field of said database.

8. The method of claim 7 wherein step (d) further comprises entering more than one selection item into the same said predetermined field of said database.

9. The method of claim 7 wherein said step (b) further comprises selecting said selection item using a mouse.

10. The method of claim 7 wherein said step (b) further comprises selecting said selection item using a touch screen.

11. The method of claim 7 wherein said step (b) further comprises selecting said selection item using voice recognition.

12. A system for entering data into a searchable database running on a computer, said system having at least one hierarchical data entry path, said path comprising at least two data entry levels, wherein each said level has a plurality of selection items, one of said selection items being used for selecting said second level.

13. The system of claim 12 wherein said selected selection item is entered into a predetermined data field of said database.

14. The system of claim 12 wherein a second selection item is entered in said predetermined data field.

15. The system of claim 12 wherein said selection items comprise an icon with a graphical representation thereon.

16. The system of claim 12 wherein said selection items comprise an icon with a text descriptor thereon.

17. The system of claim 12 wherein said computer further comprises a PDA.

18. The system of claim 12 wherein said computer further comprises a processing unit running said database and a wireless remote data entry device for entry of data into said processing unit.

19. A computer software product for data entry into a real estate database comprising a computer readable storage medium having a computer program which when loaded into a computer having a searchable database running thereon causes the computer to perform the following steps:
a) providing a first display screen having a plurality of first selection items relating to features of a real estate property;
b) enabling a user to select one of said first selection items, which results in a second display screen having a plurality of second selection items;
c) enabling said user to choose one of the said second selection items for entering into a database or going to a next display screen for presenting a next set of selection items; and
d) enabling said user to repeat step (c) until a selection has been made for entering at least one of said selection items into a predetermined field of said real estate database.

20. A method of entering data into a searchable real-estate database running on a computer, comprising the steps of:
a) providing a first display screen having a plurality of first selection items relating to features of a real estate property;
b) selecting one of said first selection items, which results in a second display screen having a plurality of second selection items;
c) choosing one of the said second selection items for entering into a database or going to a next display screen for presenting a next set of selection items; and
d) repeating step (c) until a selection has been made for entering a selection item into a predetermined field of said real estate database.

21. A data entry device for entering data into a searchable database running on a computer, comprising:
a data entry module having a user interface displaying at least one hierarchical data entry path, said path comprising at least two data entry levels, wherein each said level has a plurality of selection items, one of said selection items being used for selecting said second level;
a digital image capture and storage module able to capture and store a plurality of images; and
a processor able to tag at least one of said stored images as being associated with at least one of said selection items.

22. A data entry device according to claim 21 wherein said data entry device comprises a digital camera.

23. A method of entering data using a digital camera that is to be downloaded into a searchable database running on a computer, comprising the steps of:
a) capturing an image using said digital camera;
b) entering a selection item into a predetermined field of said database from a first set of selection items for said digital image; and
c) down loading said digital images and associated data into said database.

24. The method according to claim 23 further comprising repeating step (b) until a selection has been made for entering a selection item into a predetermined field of said database.

25. The method of claim 23 wherein step (b) further comprises entering more than one selection item into the same said predetermined field of said database.
